(19) United States
(12) Patent Application Publication
(10) Pub. No.: US 2016/0324166 A1
(43) Pub. Date: Nov. 10, 2016

(54) BREAD MADE WITH FISH OIL

(71) Applicant: Sean Mcilwain FINNIE, Hopkins, MN (US)

(72) Inventor: Sean Mcilwain FINNIE, Hopkins, MN (US)

(21) Appl. No.: 15/138,896

(22) Filed: Apr. 26, 2016

Related U.S. Application Data
(60) Provisional application No. 62/157,030, filed on May 5, 2015.

(51) Int. Cl. A21D 2/16

(52) U.S. Cl. CPC A21D 2/165

(57) ABSTRACT

Disclosed herein is bread including fish oil that is not encapsulated, that has desirable organoleptic properties, and good shelf stability. The bread may not include an added surfactant.

### CROSS REFERENCE TO RELATED APPLICATION

This application claims the benefit of U.S. Provisional Patent Application Ser. No. 62/157,030, filed May 5, 2015, entitled BREAD MADE WITH FISH OIL, which is hereby incorporated by reference in its entirety.

### TECHNICAL FIELD

The present disclosure relates generally to baked goods including fish oil that is not encapsulated. Aspects of the disclosure are particularly directed to a bread composition including fish oil that is not encapsulated and methods of preparing same.

### BACKGROUND

Fish oil is widely considered to be desirable for incorporation into the human diet because it can be a source of omega-3 fatty acids (i.e., a-linolenic acid, eicosopentaenoic (“EPA”) acid, and docosahexanenoic acid (“DHA”)). Incorporating fish oil into baked goods has proven to be challenging, however, as baked good may acquire a “fishy” aroma and taste during baking or after sitting on a shelf for some extended period of time.

It is known to incorporate encapsulated fish oil into food products. U.S. Pat. No. 7,803,414 to Van Lengerich, et al. discloses particulates containing encapsulated fish oil that may be incorporated into food products that do not have a rancid odor or taste for extended periods of time.

U.S. Pat. No. 6,969,530 to Curtis, et al. discloses microcapsules that may include fish oil and that can be incorporated into foodstuff.

The present disclosure provides baked goods including fish oil that is not encapsulated, where the baked goods have desirable organoleptic properties, both during baking and after sitting on a shelf for an extended period of time.

### SUMMARY

In one aspect, provided is a bread composition comprising: an edible oil comprising a fish oil, wherein the fish oil is not an encapsulated fish oil.

In another aspect, provided is a method of making a baked bread, the method comprising: obtaining a bread dough, wherein the bread dough comprises an edible oil comprising a fish oil, and wherein the fish oil is not an encapsulated fish oil; and baking the bread dough to provide a baked bread.

### BRIEF DESCRIPTION OF THE DRAWINGS

FIG. 1 is a graph of test and control bread specific volumes.

FIG. 2 is a graph of test and control bread firmness.

### DETAILED DESCRIPTION

Disclosed herein are breads including fish oil, particularly fish oil that is not encapsulated, that have desirable organoleptic properties and good shelf stability. It was unexpectedly found that breads produced with a vegetable oil/fish oil blend were larger in volume than control breads produced with a commercial vegetable oil that did not include fish oil, even when the bread including fish oil had no added surfactants. Furthermore, it was unexpectedly found that the breads produced with a vegetable oil/fish oil blend and without added surfactants had excellent organoleptic properties.

As used herein, the term “fish oil that is not encapsulated” refers to fish oil that has not been subjected to an encapsulation or microencapsulation process.

As used herein, the term “added surfactant” refers to a surfactant included in a formulation of a baked good that is added in addition to a surfactant that may typically be present in a baked-good ingredient such as, for example, bread flour, compressed yeast, or oil.

### Edible Oil Including a Fish Oil

Edible oils useful in embodiments of the present disclosure may include a vegetable oil and a fish oil that is not encapsulated.

Vegetable oil useful in embodiments of the present disclosure will typically be commercially refined, bleached, and deodorized, though a less-processed oil, such as an expelled oil or a cold-pressed oil, may be used. In a preferred embodiment, the vegetable oil is rapeseed oil, which encompasses what is commonly called “canola” oil in North America. Suitable rapeseed oils meeting the above-specified criteria are commercially available from Cargill, Incorporated of Wayzata, Minn., USA under the CLEAR VALLEY® trademark, such as CLEAR VALLEY 65-brand (“CV65”), CLEAR VALLEY 75-brand (“CV75”), or CLEAR VALLEY 80-brand (“CV80”) canola oils. High-oleic sunflower oil (e.g., CLEAR VALLEY brand) having at least about 65 wt % oleic acid and high-oleic, low-linolenic soybean oil may also suffice for some specific applications.

Fish oil useful in embodiments of the present disclosure are available commercially, such as, for example, MEG3 Sardine Anchovy fish oil (Ocean Nutrition Canada Limited, Dartmouth, Nova Scotia, Canada), which is a fish oil that has not been subjected to an encapsulation or microencapsulation process.

Edible oil including a fish oil suitable for use in embodiments of the present disclosure are described in U.S. Patent Application Publication No. 20140220215 to Iassonova et al., the entirety of which is incorporated herein by reference.

In some embodiments, the edible oil comprises a canola oil and about 10 wt % to about 25 wt %, about 11 wt % to about 20 wt %, or about 12 wt % to about 18 wt % of the fish oil. In some embodiments, the canola oil comprises at least 65 wt % oleic acid, at least about 75 wt % oleic acid, or at least 80% oleic acid.

In some preferred embodiments, the edible oil including fish oil may be an EPA/DHA omega-3 oil commercially available from Cargill, Incorporated of Wayzata, Minn., USA under the INGREVITA trademark, which is a canola oil/fish oil blend that includes fish oil that has not been subjected to an encapsulation or microencapsulation process.

### Surfactants

Surfactants (e.g., lecithins, monoglycerides) are commonly added to food products such as baked goods, typically in amounts of about 0.3 wt % to about 1 wt %, for their functions in starch complexing, protein strengthening, aeration, and to improve the organoleptic properties (e.g., softness, moistness, taste) of the food product.

Added surfactants excluded from embodiments of the present disclosure can include, for example, diacylglycerols, monoacylglycerols, plant lecithins, diacetyl tartaric acid esters, propylene glycol monesters, sodium stearoyl-2-lactylate, calcium stearoyl-2-lactylatesuccinylated monoglycerols, ethoxylated monoglycerols, methoxylated diglycerols, polysorbate 60, sodium stearyl fumarate, lactylic stearate, lactylated monoglycerol, acetylated monoglycerol, lactylated propylene glycol monoester, sorbitan monostearate, polyglycerol esters, sucrose esters, sucrose glycerols, hydroxylated lecithins, and combinations thereof.

### Flours

Flour used in baking applications is often produced from wheat, though flour can be milled from materials such as corn, rice, nuts, legumes, fruits, and vegetables. Flour useful in embodiments of the present disclosure may include a wheat flour. Suitable wheat flours can include, for example, a white flour, a brown flour, or a whole-wheat flour (e.g., white, red). In some embodiments, the wheat flour may include an all-purpose flour, a bleached flour, a bread flour, a bolted flour, a bromated flour, a chapati flour, an enriched flour, a cake flour, a farina, a gluten flour, a graham flour, a pastry flour, a self-rising flour, and combinations thereof. In some preferred embodiments, the flour may be a white flour. In some preferred embodiments, the flour may be a white whole-wheat flour. In some preferred embodiments, the flour may be a red whole-wheat flour.

### Bread Compositions

Methods of making bread compositions are known to the person having ordinary skill in the art and are disclosed by Labensky et al. On Baking: A Textbook of Baking and Pastry Fundamentals (3rd Edition) Prentice Hall, 2012.

In one aspect, bread compositions of the present disclosure are prepared using an edible oil comprising a fish oil, where the fish oil is not an encapsulated fish oil. In some embodiments, the edible oil comprises a canola oil and about 10 wt % to about 25 wt %, about 11 wt % to about 20 wt %, or about 12 wt % to about 18 wt % of the fish oil. In some embodiments, the canola oil comprises at least 65 wt % oleic acid, at least about 75 wt % oleic acid, or at least 80% oleic acid.

In another aspect, bread compositions of the present application are prepared without an added surfactant, such as those listed above.

Bread specific volume is a measure of the volume of a bread in cubic centimeters occupied by a gram of bread. Methods for the determination of bread volume are known in the art, and may be accomplished using, for example, a TexVol BVM-L 500 analyzer (Perten Instruments, Hagersten, Sweden). In some embodiments, bread specific volume is at least about 5%, at least about 6%, at least about 7%, at least 5 about 8%, at least about 9%, or at least about 10% larger than the volume of a similar bread prepared without the edible oil comprising the fish oil. In some embodiments, bread specific volume is about 5% to about 10% larger than the volume of a similar bread prepared without the edible oil comprising the fish oil.

In some embodiments, bread specific volume is at least about 5%, at least about 6%, at least about 7%, at least 5 about 8%, at least about 9%, or at least about 10% larger than the volume of a similar bread prepared without the edible oil comprising the fish oil and with added surfactant. In some embodiments, bread specific volume is about 5% to about 10% larger than the volume of a similar bread prepared without the edible oil comprising the fish oil and with added surfactant.

The U.S. Food and Drug Administration sets a “reference amount” for determining an appropriate serving size for a given food product in the U.S., with the reference amount varying from one type of food product to another. As used herein, the term “FDA Reference Serving Size” for a given food product is the “reference amount” set forth in 21 CFR §101.12 as of Apr. 1, 2014. The FDA Reference Serving Size for breads (excluding sweet quick type) is 50 g. For example, a food manufacturer may intend to produce a bread. If the bread includes 2 g of an edible fat having 1.65 wt % EPA plus DHA per 50 g FDA Reference Serving Size, the edible fat would contribute about 33 mg of EPA plus DHA per serving.

In some embodiments, bread compositions prepared according to the present disclosure may include at least about 16 mg of EPA plus DHA per FDA Reference Serving Size. In some embodiments, bread compositions prepared according to the present disclosure may include at least about 32 mg of EPA plus DHA per FDA Reference Serving Size.

### Shelf Life

Testing has demonstrated that bread products produced in accordance with embodiments of the present disclosure and stored at about 70° F. have no material increase in an off-flavor or an off-aroma and have the no significant difference in firmness in comparison to a control bread product that is formed in the same manner but without fish oil (e.g., without 32 mg of EPA plus DHA per FDA reference serving size of the bread product), or without fish oil (e.g., 32 mg of EPA plus DHA per FDA reference serving size of the bread product) and without added surfactant, for at least up to 21 days.

In particular, overall liking and preference testing by sensory panelists have demonstrated that bread products prepared in accordance with aspects of the present disclosure reliably yield a bread that has the same overall liking and preference in comparison to a control bread product that is formed in the same manner, but without fish oil and with added surfactants, when stored at about 70° F. for at least about 1 day, at least about 2 days, at least about 3 three days, at least about 4 days, at least about 5 days, at least about 6 days, at least about 7 days, at least about 8 days, at least about 9 days, at least about 10 days, at least about 11 days, at least about 12 days, at least about 13 days, at least about 14 days, at least about 15 days, at least about 16 days, at least about 17 days, at least about 18 days, at least about 19 days, at least about 20 days, or at least about 21 days.

### EXAMPLES

### Example 1

### Preparation of White Breads

### Materials

Wheat bread flour (Cargill, Incorporated, Wayzata, Minn., USA), sugar (Cargill, Incorporated, Wayzata, Minn., USA), salt (Cargill, Incorporated, Wayzata, Minn., USA), non-fat dry milk (American Dairy Products Institute, Elmhurst, Ill., USA), Softase 4000 enzyme (AB Mauri, London, England), Fleischmann's calcium propionate (AB Mauri, London, England), Topcithin UB lecithin (Cargill, Incorporated, Wayzata, Minn., USA), GMS-90 monoglycerides (Corbion, Lenexa, Kans., USA), apple cider vinegar (Topco Holdings, Inc., Skokie, Ill., USA), Fleischmann's compressed yeast (AB Mauri, London, England), soybean oil (Cargill, Incorporated, Wayzata, Minn., USA), and ICS 75p (AB Mauri, London, England).

Canola/Fish Oil Blend:

CLEAR VALLEY 65-brand canola oil (Cargill, Incorporated, Wayzata, Minn., USA) is combined with MEG3 Sardine Anchovy fish oil from Ocean Nutrition Canada Limited, Dartmouth, Nova Scotia, Canada to provide a blend of canola oil and fish oil (“Canola/Fish Oil Blend”). The Canola/Fish Oil Blend includes enough combined eicosopentaenoic acid and docosahexanenoic acid (“EPA plus DHA”) to provide about 32 mg/50 g bread serving of EPA plus DHA in the bread product. The Canola/Fish Oil Blend is prepared by mixing the canola oil with about 12 wt % to about 18 wt % of the fish oil (specific fish oil lots provide varying amounts of EPA and DHA) to which an antioxidant blend of rosemary extract and ascorbic acid sold by Kalsec Inc. of Kalamazoo, Mich., USA is added (0.3 wt % of the weight of the oil).

Commercially representative white bread formulas (percent of each ingredient in dough by weight) were developed and are shown in Table 1.

| | Formula A | | Formula B | |
|---|---|---|---|---|
| | Control | Test | Control | Test |
| White Bread (Wheat) | 1 | 1 | 2 | 2 |
| Bread flour (wheat) | 54.44% | 54.44% | 54.74% | 54.74% |
| Sugar | 4.36% | 4.36% | 4.38% | 4.38% |
| Salt | 1.09% | 1.09% | 1.09% | 1.09% |
| Nonfat dry milk | 1.09% | 1.09% | 1.09% | 1.09% |
| Softase 4000 | 0.19% | 0.19% | 0.19% | 0.19% |
| Calcium propionate | 0.19% | 0.19% | 0.19% | 0.19% |
| Topcithin UB lecithin | 0.27% | 0.27% | . | . |
| GMS-90 | | | | |
| monoglycerides | 0.27% | 0.27% | . | . |
| Apple cider vinegar | 0.54% | 0.54% | 0.55% | 0.55% |
| Compressed yeast | 2.72% | 2.72% | 2.74% | 2.74% |
| Water | 31.13% | 31.13% | 31.30% | 31.30% |
| Soybean oil | 3.50% | . | 3.52% | . |
| Canola/Fish Oil Blend | . | 3.50% | . | 3.52% |
| ICS 75p | 0.20% | 0.20% | 0.21% | 0.21% |
| Total | 100.00% | 100.00% | 100.00% | 100.00% |

Each of the four bread formulas in Table 1 was used to produce a bread dough. Method: All ingredients were placed into the bowl of a PHEBUS SPI 52-S spiral mixer (VMI, Paris, France). The ingredients were mixed for one minute on speed 1, followed by mixing for nine minutes on speed 2. Dough was taken out of mixer and allowed to rest for 10 minutes at room temperature (about 23° C.). After resting, the dough was divided into six 420 gram sections, rolled into spheres, and was allowed to rest for another 10 minutes at room temperature. Dough samples were then processed through a model 500 sheeter moulder (Moline Machinery LLC, Duluth, Minn., USA), placed into six bread pans and proofed for 45 minutes at 85% relative humidity at 46° C. in a model LRP2 Proofer (LBC Bakery Equipment, Inc., Everett, Wash., USA). After proofing, the samples were baked in a rack oven, model LRO-1G (LBC Bakery Equipment, Inc., Everett, Wash., USA), for 22 minutes at 193° C. After baking, the bread was removed from pans and cooled to room temperature. The cooled bread was sliced using a model 797-32 bread slicer (Oliver Packaging and Equipment Company, Walker, Mich., USA) to a thickness of 0.5 inches.

Bread volumes were determined using a TexVol BVM-L 500 analyzer (Perten Instruments, Hagersten, Sweden). Bread crumb grain characteristics were analyzed using a C-CELL image analyzer (Calibre Control International Ltd., Warrington, United Kingdom). Bread firmness was determined using a TA.XT plus texture analyzer and a TA-11 one-inch diameter cylinder acrylic probe (Stable Micro Systems, Surrey, United Kingdom). Testing parameters for the texture analyzer were: test mode—Compression; pre-test speed—10 mm/sec; test speed—two mm/sec; post-test speed—10 mm/sec; 50% strain; and trigger pressure of five grams.

### Results

### Bread Specific Volume

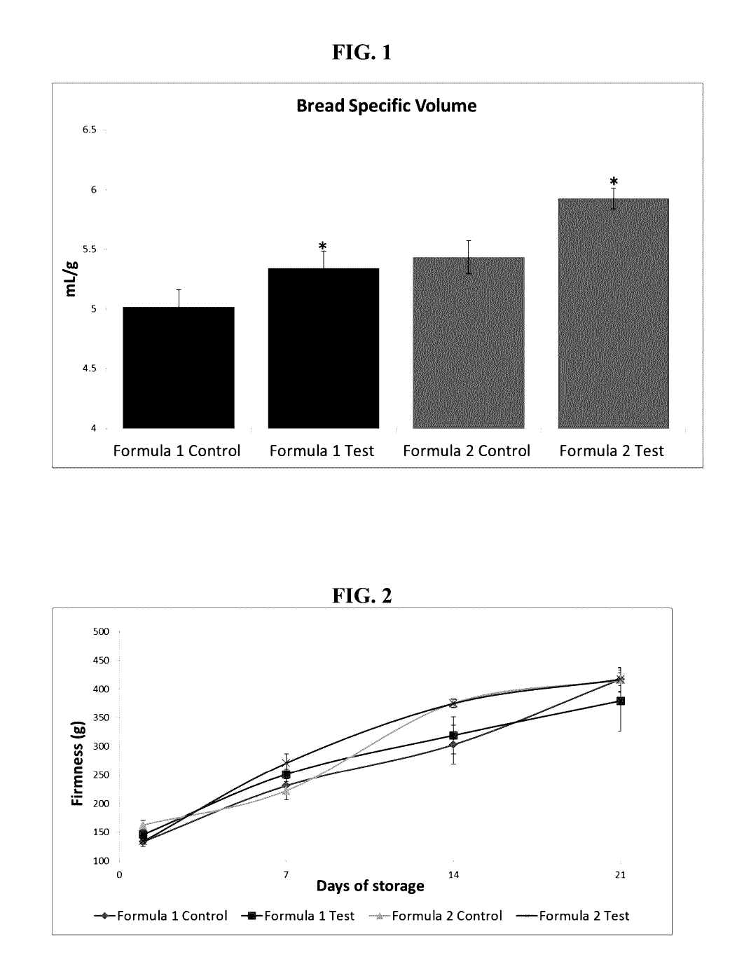

FIG. 1 is a graph of bread specific volumes for Test Samples 1 and 2 and Control Samples 1 and 2. The “* ‘indicates the mean bread specific volume for the test samples are statistically significantly different than the control samples, P-value <0.05. Bread specific volume data show that the inclusion of the canola oil/fish oil blend significantly increased the bread loaf volume compared to the control prepared with soybean oil, with a 6.6% increase in bread loaf volume for Formula 1 and a 9.2% increase in bread loaf volume for Formula 2 compared to the controls. Surprisingly, the absence of added surfactants in the Test Samples did not result in decreased bread loaf volume.

### Bread Crumb Characteristics

The C-CELL data, as presented in Table 2, show that despite the increase in bread specific volumes, neither the inclusion of canola oil/fish oil blend nor the absence of added surfactants had a significant impact on the internal crumb characteristics of the bread. The number of gas cells and the diameter of the gas cells were statistically similar to each other. Furthermore, the shape of the bread (indicated by concavity) was not impact by the inclusion of omega-3 containing oil.

TABLE 2
C-CELL Data

| | | Control | Test | Control | Test |
|---|---|---|---|---|---|
| | | 1 | 1 | 2 | 2 |
| Number of Gas Cells | Mean | 5130.2 | 4895.4 | 5560.6 | 5758.0 |
| | Std | 237.4 | 683.3 | 179.5 | 416.1 |
| Gas Cell Diameter (px) | Mean | 16.4 | 16.5 | 15.3 | 15.2 |
| | Std | 0.8 | 1.2 | 0.3 | 0.7 |
| Concavity of Bread | Mean | 6.7 | 6.5 | 7.0 | 5.8 |
| (%) | Std | 0.9 | 0.6 | 0.8 | 0.7 |

### Bread Firmness

The firmness of the bread was measured at days one, seven, fourteen, and twenty-one (FIG. 2). The bread was stored at about 70° F., in the dark and without humidity control. Referring to FIG. 2, no significant differences in firmness over the observation period were observed between the Control Samples and the Test Samples.

### Conclusions

The inclusion of a canola oil/fish oil blend, where the fish oil is not an encapsulated fish oil, in bread formulations, even in the absence of added surfactants, resulted in bread specific volumes that are larger than bread made with standard commercial vegetable oil and added surfactants. C-CELL data and bread firmness of bread prepared with a canola oil/fish oil blend and without added surfactants were comparable to bread made with standard commercial vegetable oil and with added surfactants

### Example 2

### Bread Sensory Analysis

Materials:

Wheat flours (Cargill, Incorporated, Wayzata, Minn., USA), sugar (Cargill, Incorporated, Wayzata, Minn., USA), salt (Cargill, Incorporated, Wayzata, Minn., USA), non-fat dry milk (American Dairy Products Institute, Elmhurst, Ill., USA), vital wheat gluten (Cargill, Incorporated, Wayzata, Minn., USA), UFS 400 enzyme (Corbion, Lenexa, Kans., USA), POLAR TEX 12640 modified starch (Cargill, Incorporated, Wayzata, Minn., USA), VISCOGUM locust bean gum (Cargill, Incorporated, Wayzata, Minn., USA), sodium stearoyl-2-lactylate (Corbion, Lenexa, Kans., USA) calcium sulfate (Allied Custom Gypsum, Norman, Okla., USA), Fleischmann's calcium propionate (AB Mauri, London, England), TOPCITHIN UB lecithin (Cargill, Incorporated, Wayzata, Minn., USA), glycerol monostearate (Corbion, Lenexa, Kans., USA), apple cider vinegar (Topco Holdings, Inc., Skokie, Ill., USA), Fleischmann's compressed yeast (AB Mauri, London, England), soybean oil (Cargill, Incorporated, Wayzata, Minn., USA), molasses (B & G Foods, Inc., Parsippany, New jersey, USA), azodicarbonamide (AB Mauri, London, England), and ascorbic acid (AB Mauri, London, England).

Canola/Fish Oil Blend:

CLEAR VALLEY 65-brand canola oil (Cargill, Incorporated, Wayzata, Minn., USA) is combined with MEG3 Sardine Anchovy fish oil from Ocean Nutrition Canada Limited, Dartmouth, Nova Scotia, Canada to provide a blend of canola oil and fish oil (“Canola/Fish Oil Blend”). The Canola/Fish Oil Blend includes enough combined eicosopentaenoic acid and docosahexanenoic acid (“EPA plus DHA”) to provide about 32 mg/50 g bread serving of EPA plus DHA in the bread product. The Canola/Fish Oil Blend is prepared by mixing the canola oil with about 12 wt % to about 18 wt % of the fish oil (specific fish oil lots provide varying amounts of EPA and DHA) to which an antioxidant blend of rosemary extract and ascorbic acid sold by Kalsec Inc. of Kalamazoo, Mich., USA is added (0.3 wt % of the weight of the oil).

Bread samples were prepared according to the method of Example 1, using the formulas provided in Tables 3a-3c. The bread was stored at about 70° F., in the dark and without humidity control.

TABLE 3a
White Bread Formula

| | Control | Test |
|---|---|---|
| Ingredients | % | % |
| Artisan Flour/ | 54.161% | 54.161% |
| Bread Flour | | |
| (wheat) | | |
| Sugar | 4.333% | 4.333% |
| Salt | 1.083% | 1.083% |
| UFS 400 | 0.487% | 0.487% |
| Polar Tex 12640 | 0.812% | 0.812% |
| Viscogum | 0.217% | 0.217% |
| sodium steroyl 2- | 0.179% | 0.179% |
| lactolate | | |
| Calcium sulfate | 0.000% | 0.000% |
| Calcium | 0.271% | 0.271% |
| propionate | | |
| GMS 90 | 0.542% | 0.542% |
| Soybean oil | 2.437% | 0.000% |
| Canola/Fish Oil | 0.000% | 2.437% |
| Blend | | |
| Yeast | 2.166% | 2.166% |
| Water | 31.955% | 31.955% |
| Apple cider | 1.354% | 1.354% |
| vinegar | | |
| Azodicarbonamide | 0.003% | 0.003% |
| (40 ppm) | | |
| Ascorbic acid | 0.000% | 0.000% |
| (100 ppm) | | |
| Total | 100% | 100% |

TABLE 3b
White Whole-Wheat Bread Formula

| | Control | Test |
|---|---|---|
| Ingredients | % | % |
| White whole- | 49.534% | 49.534% |
| wheat flour | | |
| Sugar | 4.458% | 4.458% |
| Salt | 0.991% | 0.991% |
| Nonfat dry milk | 0.000% | 0.000% |
| Vital wheat gluten | 2.477% | 2.477% |
| Sodium stearoyl-2- | 0.152% | 0.152% |
| lactylate | | |
| Calcium sulfate | 0.173% | 0.173% |
| Calcium | 0.173% | 0.173% |
| propionate | | |
| GMS 90 | 0.495% | 0.495% |
| Soybean oil | 2.402% | 0.000% |
| Canola/Fish Oil | 0.000% | 2.402% |
| Blend | | |
| Yeast | 2.477% | 2.477% |
| Vinegar | 0.991% | 0.991% |
| Water | 35.169% | 35.169% |
| Molasses | 0.495% | 0.495% |
| Azodicarbonamide | 0.003% | 0.003% |
| (40 ppm) | | |
| Ascorbic acid | 0.008% | 0.008% |
| (100 ppm) | | |
| Total | 100% | 100% |

TABLE 3c
Red Whole-Wheat Bread Formula

| | Control | Test |
|---|---|---|
| Ingredients | % | % |
| Red whole-wheat flour | 48.789% | 48.789% |
| Sugar | 4.391% | 4.391% |
| Salt | 0.976% | 0.976% |
| Vital wheat gluten | 2.439% | 2.439% |
| Enzyme UFS 400 | 0.439% | 0.439% |
| Polar Tex 12640 | 0.732% | 0.732% |
| Viscogum | 0.195% | 0.195% |
| Sodium stearoyl-2- | 0.150% | 0.150% |
| lactylate | | |
| Calcium sulfate | 0.000% | 0.000% |
| Calcium pPropionate | 0.244% | 0.244% |
| GMS 90 | 0.488% | 0.488% |
| Soybean oil | 2.366% | 0.000% |
| Canola/Fish Oil Blend | 0.000% | 2.366% |
| Yeast | 2.439% | 2.439% |
| Apple cider vinegar | 1.220% | 1.220% |
| Water | 34.640% | 34.640% |
| Molasses | 0.488% | 0.488% |
| Azodicarbonamide | 0.003% | 0.003% |
| (40 ppm) | | |
| Ascorbic acid | 0.000% | 0.000% |
| (100 ppm) | | |
| Total | 100% | 100% |

TABLE 4
Bread Sensory Analysis

| | | Bread Age | |
|---|---|---|---|
| Wheat | | on the | |
| Bread | | Test Date | Number of |
| Variety | Samples | (Days) | Panelists |
| White | Control | 7 | 84 |
| | and | 14 | 75 |
| | Test | 21 | 81 |
| White | Control | 6 | 99 |
| Whole- | and | 9 | 77 |
| Wheat | Test | 14 | 66 |
| Red Whole- | Control | 7 | 76 |
| Wheat | and | 14 | 82 |
| | Test | 21 | 74 |

Untrained sensory panelists were served one half of a whole slice of bread on a 6-inch white plate at room temperature. The sensory panelists were instructed to rinse well with water in between each sample. Samples were served in a balanced randomized order, one at a time. Sensory panelists use a 9-point hedonic scale (1 is the lowest score) where a score of 9 is “Like Extremely” and a 1 is “Dislike Extremely” for “Overall Liking (Table 5). For preference, panelist ranked samples, with “1” being the most-preferred sample, and with “2” being the least-preferred sample.

A summary of the sensory test results are shown in Tables 5-6. Referring to Tables 5 and 6, means followed by different letters are significantly different from each other at p<0.05.

TABLE 5
Overall Liking

| Wheat Bread | | | | | |
|---|---|---|---|---|---|
| Variety | Samples | 6-7 Days | 9 Days | 14 Days | 21 Days |
| White | Control | 6.6 a | — | 6.6 a | 6.8 a |
| | Test | 6.8 a | — | 6.4 a | 6.5 a |
| White Whole- | Control | 5.9 a | 5.8 a | 6.0 a | |
| Grain | Test | 5.8 a | 6.0 a | 6.0 a | |
| Red Whole- | Control | 6.1 a | — | 6.1 a | 6.2 a |
| Grain | Test | 6.3 a | — | 6.4 a | 6.3 a |

TABLE 6
Preference

| Wheat Bread | | | | |
|---|---|---|---|---|
| Variety | Samples | 6-7 Days | 14 Days | 21 Days |
| White | Control | 54% a | 56% a | 56% a |
| | Test | 46% a | 44% a | 44% a |
| Red Whole- | Control | 41% a | 43% a | 53% a |
| Grain | Test | 59% a | 57% a | 47% a |

The data of Table 5 show that the overall liking of the control bread and the test breads were statistically the same over a 21-day period, i.e., they were not significantly different.

The data of Table 6 show that one bread sample was not statistically preferred over the other over a 21-day period, i.e., the panelists had no preference for either the control bread or the test bread.

### Conclusions

Results show that a canola oil/fish oil blend may be used in white and whole-wheat bread formulas without significantly impacting the overall liking and preference of panelists for these types of breads.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. When the claims use the word “or” in reference to a list of two or more items, that word covers all of the following interpretations of the word: any of the items in the list, all of the items in the list, and any combination of the items in the list.

The above detailed descriptions of embodiments of the invention are not intended to be exhaustive or to limit the invention to the precise form disclosed above. Although specific embodiments of, and examples for, the invention are described above for illustrative purposes, various equivalent modifications are possible within the scope of the invention, as those skilled in the relevant art will recognize. For example, while steps are presented in a given order, alternative embodiments may perform steps in a different order. The various embodiments described herein can also be combined to provide further embodiments.

In general, the terms used in the following claims should not be construed to limit the invention to the specific embodiments disclosed in the specification, unless the above detailed description explicitly defines such terms. While certain aspects of the invention are presented below in certain claim forms, the inventors contemplate the various aspects of the invention in any number of claim forms. Accordingly, the inventors reserve the right to add additional claims after filing the application to pursue such additional claim forms for other aspects of the invention.

What is claimed is:

1. A bread composition comprising:
an edible oil comprising a fish oil,
wherein the fish oil is not an encapsulated fish oil.

2. The bread composition of claim 1, wherein the edible oil comprises a canola oil and about 12 wt % to about 18 wt % of the fish oil.

3. The bread composition of claim 2, wherein the canola oil comprises at least 65 wt % oleic acid.

4. The bread composition of claim 1, wherein the bread composition does not include an added surfactant.

5. The bread composition of claim 4, wherein the added surfactant is selected from the group consisting of diacylglycerols, monoacylglycerols, lecithins, diacetyl tartaric acid esters, peropylene glycol monesters, sodium stearoyl-2-lactylate, calcium stearoyl-2-lactylatesuccinylated monoglycerols, ethoxylated monoglycerols, methoxylated diglycerols, polysorbate 60, sodium stearyl fumarate, lactylic stearate, lactylated monoglycerol, acetylated monoglycerol, lactylated propylene glycol monoester, sorbitan monostearate, polyglycerol esters, sucrose esters, sucrose glycerols, hydroxylated lecithins, and combinations thereof.

6. The bread composition of claim 1, further comprising at least one of a white flour, a white whole-grain flour, and a red whole-grain flour.

7. The bread of claim 1, wherein the bread specific volume is at least about 5% to 10% larger than the volume of a similar bread prepared without the edible oil comprising the fish oil.

8. The bread of claim 4, wherein the bread specific volume is at least about 5% to 10% larger than the volume of a similar bread prepared without the edible oil comprising the fish oil and with added surfactant.

9. A method of making a baked bread, the method comprising:
obtaining a bread dough, wherein the bread dough comprises an edible oil comprising a fish oil, and wherein the fish oil is not an encapsulated fish oil; and
baking the bread dough to provide a baked bread.

10. The method of claim 9, wherein the edible oil comprises a canola oil and about 12 wt % to about 18 wt % of the fish oil.

11. The method of claim 10, wherein the canola oil comprises at least 65 wt % oleic acid.

12. The method of claim 9, wherein the bread composition does not include an added surfactant.

13. The method of claim 12, wherein the added surfactant is selected from the group consisting of diacylglycerols, monoacylglycerols, lecithins, diacetyl tartaric acid esters, peropylene glycol monesters, sodium stearoyl-2-lactylate, calcium stearoyl-2-lactylatesuccinylated monoglycerols, ethoxylated monoglycerols, methoxylated diglycerols, polysorbate 60, sodium stearyl fumarate, lactylic stearate, lactylated monoglycerol, acetylated monoglycerol, lactylated propylene glycol monoester, sorbitan monostearate, polyglycerol esters, sucrose esters, sucrose glycerols, hydroxylated lecithins, and combinations thereof.

14. The method of claim 9, wherein the baked bread specific volume is at least about 5% to 10% larger than the volume of a similar bread prepared without the edible oil comprising the fish oil.

15. The method of claim 12, wherein the baked bread specific volume is at least about 5% to 10% larger than the volume of a similar bread prepared without the edible oil comprising the fish oil and with added surfactant.
